(19) United States
(12) Patent Application Publication
(10) Pub. No.: US 2005/0005156 A1
(43) Pub. Date: Jan. 6, 2005

(54) Cryptographic-key management device

(75) Inventor: W. Jack Harper, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 10/844,963

(22) Filed: May 12, 2004

Related U.S. Application Data
(60) Provisional application No. 60/470,479, filed on May 13, 2003.
(60) Provisional application No. 60/543,596, filed on Feb. 10, 2004.

(51) Int. Cl. H04L 9/00

(52) U.S. Cl. 713/200

(57) ABSTRACT

A cryptographic-key management device is provided. A secure cryptographic module is provided with a first memory storing a private cryptographic key of multiple public/private key pairs. The secure cryptographic module is adapted to zeroize the first memory in response to physical disruption of the module. A secure microcontroller is provided in communication with and adapted to control operation of the secure cryptographic module. The secure microcontroller has a second memory storing the public keys of the public/private key pains and a self-destruct pin whose activation disables the microcontroller. A package encapsulates the secure cryptographic module and the secure microcontroller, and is linked with the self-destruct pin to activate the self-destruct pin in response to a breach of the package.

### CROSS REFERENCE TO RELATED APPLICATION

This application is a nonprovisional of: U.S. Prov. Pat. Appl. No. 60/470,479, entitled “CRYPTOGRAPHICALLY SECURE TRANSACTIONS WITH OPTICAL CARDS,” filed May 13, 2003 by Jack Harper; and U.S. Prov. Pat. Appl. No. 60/543,596, filed Feb. 10, 2004 by W. Jack Harper, the entire disclosures of both of which are incorporated herein by reference for all purposes.

This application is also related to the following commonly assigned, concurrently filed applications, the entire disclosures of which are incorporated herein by reference for all purposes: U.S. patent application Ser. No. ______, entitled “CRYPTOGRAPHICALLY SECURE TRANSACTIONS WITH OPTICAL CARDS,” by W. Jack Harper (Attorney Docket No. 040172-000810US), which is a nonprovisional of U.S. Prov. Pat. Appl. No. 60/543,595, filed Feb. 10, 2004 W. Jack Harper; and U.S. patent application Ser. No. ______, entitled “HARDWARE RANDOM-NUMBER GENERATOR,” by W. Jack Harper (Attorney Docket No. 040172-001010US), which is a nonprovisional of U.S. Prov. Pat. Appl. No. 60/543,797, filed Feb. 10, 2004 by W. Jack Harper.

### BACKGROUND OF THE INVENTION

This application relates generally to optical cards. More specifically, this application relates to cryptographic security of optical cards.

The development of optical cards has been relatively recent. They are cards that are typically made to be about the size of a standard credit card and which store digitized information in an optical storage area. While the storage capacity of such cards may be relatively high, the basic data on the card are relatively easily extracted. Individual data bits on the card are typically about 2 μm in diameter and can be recovered by magnified examination of the card. While this ease of recovery may not be a significant concern for some types of data, it does present a barrier to storing sensitive data on the card. Such sensitive data may be stored in an encrypted format, but a fundamental concern is where to store the secret key used to decrypt the data. The key cannot simply be stored within the optical storage area on the card itself because it would then be as easy to extract as the data.

A number of attempted approaches to optical-card systems that encrypt data suffer from deficiencies that compromise the security of the keys. For instance, in such a system, the keys may be embedded in software that is used in extracting data from the optical cards. But with this method, an attacker can reverse engineer the software object file to recover the key. This method also compounds the security issue since megabytes of software need be protected rather than only the much smaller key.

In another approach, an attempt at obfuscating the key may be tried by embedding the key in the microcode of hardware used in extracting data from the optical cards. This approach suffers from a similar deficiency in that an attacker can reverse engineer the electronics and control microcode to recover the key or its cryptographic function. While this is somewhat more difficult than reverse engineering pure software, it still leaves the keys open to attack while also compounding the security issue by requiring hardware and its microcode to be protected against theft.

Another possibility is to embed a smart-card chip into the optical card to produce a hybrid card, with key storage assigned to the smart-card chip. This approach more than doubles the cost of the card system, and relinquishes the simplicity of a stand-alone system by requiring that the system be inherently online. Furthermore, smart-card chips themselves suffer from a number of security deficiencies. They typically use a form of flash memory that may be read by shaving the outer housing and illuminating the die with a scanning electron microscope to read the bits.

The use of any of these techniques, or of a combination of these techniques, leaves significant security risks in a cryptographic optical-card system. There is accordingly a general need in the art for a system that enables cryptographically secure transactions to be performed with optical cards.

### BRIEF SUMMARY OF THE INVENTION

Embodiments of the invention provide a cryptographic-key management device. A secure cryptographic module is provided with a first memory storing a private cryptographic key of a plurality of public/private key pairs. The secure cryptographic module is adapted to zeroize the first memory in response to physical disruption of the module. A secure microcontroller is provided in communication with and adapted to control operation of the secure cryptographic module. The secure microcontroller comprises a second memory storing the public keys of the plurality of public/private key pains and a self-destruct pin whose activation disables the microcontroller. A package encapsulates the secure cryptographic module and the secure microcontroller, and is linked with the self-destruct pin to activate the self-destruct pin in response to a breach of the package.

The physical disruption that results in zeroization of the first memory may comprise a breach of a container housing the first memory, a deviation in temperature of the module outside of a predefined range, or a deviation in strength of an electromagnetic field near the module outside of a predefined range, for example. The package may comprise a brittle wire connected with the self-destruct pin. The wire may be wrapped, perhaps in multiple layers, about the secure cryptographic module and secure microcontroller. In some instances, the package comprises an encapsulating material that includes an epoxy substance and at least one of a silica and an alumina. In one embodiment, the secure microcontroller comprises a second self-destruct pin whose activation also disables the microcontroller, with the second self-destruct pin connected to a tamper sensor internal to a housing. In some instances, the cryptographic-key management device may further comprise a random-number generator, such as a hardware random-number generator.

Such cryptographic-key management devices may be used in an optical-card network that comprises a plurality of transaction processing units and a plurality of optical cards. Each transaction processing unit may comprise a cryptographic-key management device having a securely stored private key for that cryptographic-key management device and securely stored public keys for a plurality of cryptographic-key management devices, an optical-card read/write drive adapted to exchange data with optical cards, and a processor to control operation of the cryptographic-key management device and the optical-card read/write drive. In some instances, the cryptographic-key management devices may have the structure and characteristics described above. In some embodiments, information may be exchanged among the plurality of transaction processing units only with the plurality of optical cards, while in other embodiments the transaction processing units may be interconnected electronically.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides schematic illustrations of different forms of optical cards that may be used in embodiments of the invention;

FIGS. 2A and 2B provide schematic illustrations of different system arrangements that may be used to support the use of optical cards;

FIG. 3 provides a perspective illustration of a transaction processing unit that may be used in the systems of FIGS. 2A and 2B;

FIG. 4 provides a schematic illustration of a cryptographic-key management device that may be integrated within the transaction processing unit of FIG. 3 in an embodiment of the invention;

FIG. 5A is a flow diagram illustrating a method for securely forming a cryptographic-key management device like the one illustrated in FIG. 4;

FIG. 5B provides a series of schematic illustrations showing the formation of a cryptographic-key management device using the method of FIG. 5A;

FIG. 6 provides an exploded view of a cryptographic module used on a cryptographic-key management device in one embodiment of the invention;

FIG. 7 provides a schematic illustration of a hardware random-number generator used on a cryptographic-key management device in one embodiment of the invention;

FIG. 8 graphically summarizes results of tests of the hardware random-number generator illustrated in FIG. 7;

FIG. 9 provides a schematic overview of a cryptographic protocol that makes use of a cryptographic-key management device like the one illustrated in FIG. 4;

FIG. 10 is a flow diagram illustrating a method for booting a transaction processing unit that uses the cryptographic protocol in one embodiment;

FIG. 11 is a flow diagram illustrating a method for writing a secure record to an optical card using the cryptographic protocol in one embodiment; and

FIG. 12 is a flow diagram illustrating a method for reading a secure record from an optical card using the cryptographic protocol in one embodiment.

### DETAILED DESCRIPTION OF THE INVENTION

Embodiments of the invention permit the support of cryptographically secure transactions using optical cards. Such optical cards may be of the specific type described in U.S. Pat. No. 5,979,772, entitled “OPTICAL CARD” by Jiro Takei et al., the entire disclosure of which is incorporated herein by reference for all purposes, but more generally includes any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 1000 times the amount of information as a typical smart card. Unlike smart cards, optical cards are also impervious to electromagnetic fields, including static electricity, and they are not damaged by normal bending and flexing.

These properties of optical cards, particularly their large storage capacity, make them especially versatile for numerous different types of transactions. Merely by way of example, a single optical card could store fingerprint biometrics for all ten fingers, iris biometrics for both eyes, hard-geometry specifications for both hands, and a high-resolution color photograph of a cardholder while using far less than 1% of its capacity. This large storage capacity also allows information for essentially every transaction that involves the card to be written to the card and thereby provide a permanent detailed audit trail of the card's use.

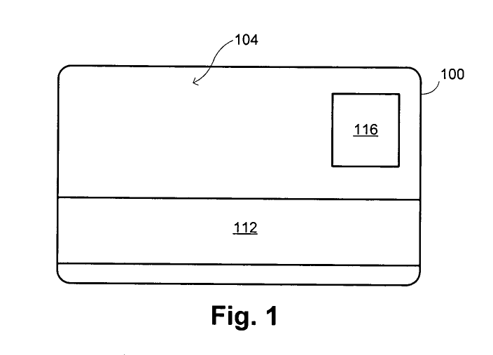

FIG. 1 provides a diagram illustrating a structure for an optical card in one embodiment. The card 100 includes an inked cardholder photograph 116, an optical storage area 112, and a printed area 104 on one side of the card. The other side of the card could include other features, such as a bar code(s) or other optically recognizable code, a signature block, counterfeiting safeguards, and the like. The printed area 104 could include any type of information, such as information identifying the cardholder so that in combination with photograph 116 acts as a useful aid in authenticating a cardholder's identity. The printed area 104 could also include information identifying the issuer of the card, and the like. The optical storage area may also comprise a plurality of individual sections, which may be designated individually by an addressing system.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser burns a small hole, about 2 μm in diameter, in the material; the hole can be sensed by a low-power laser during a read cycle. The presence or absence of the burn spot defines a binary state that is used to encode data. In some embodiments, the data can be encoded in a linear x-y format described in detail in the ISO/IEC 11693 and 11694 standards, the entire contents of which are incorporated herein by reference for all purposes.

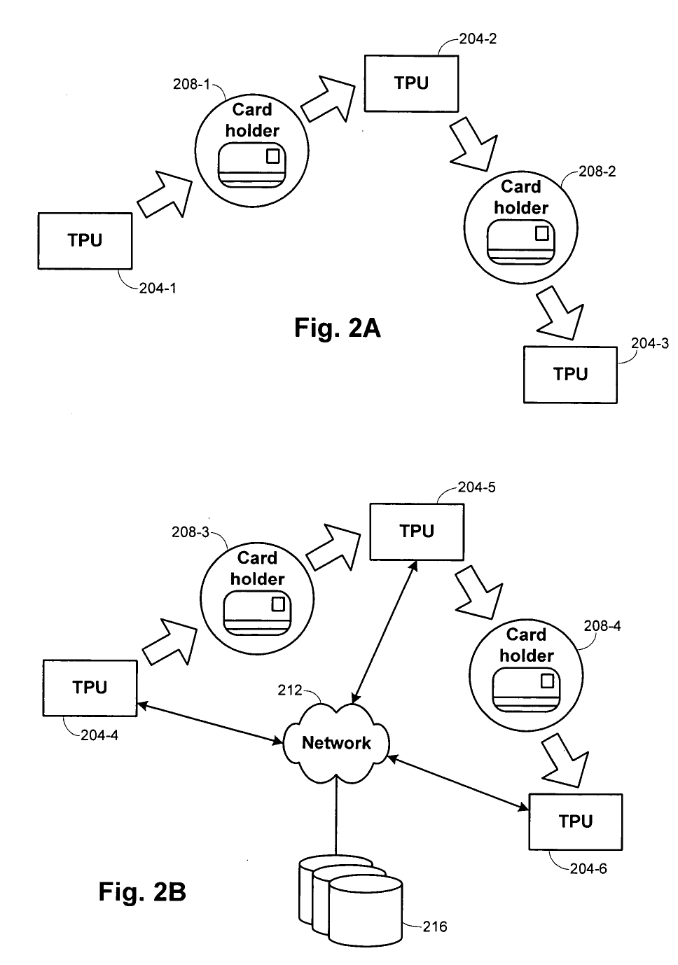

Optical cards may be used in a variety of different network structures, some of which avoid the large, complex, and expensive online systems that are inherently needed with smart cards. For example, FIG. 2A schematically illustrates a network in which a plurality of transaction processing units (“TPUs”) 204 are interconnected solely by optical cards. Transaction information is stored only on the optical cards carried by cardholders 208, rather being stored in any central or local database. As used herein, reference to “transaction information” is thus intended to include any information that may be used in executing or be the result of any type of transaction performed with an optical card, including identification, financial, access, and numerous other types of transactions. For example, in one type of access transaction, a particular cardholder 208-1 may be granted access to a secure facility with that person's optical card including digitized identification and/or biometric information such as name, age, sex, record fingerprints, iris scans, and the like. The access authorization may be written to that person's card by TPU 204-1 after confirming his identity with information already on the card. Subsequently, when the cardholder wishes to access the facility, his identity and access authorization may be confirmed by TPU 204-2 from information on the card without it even needing to be stored in a database.

This ability to avoid storage of certain types of information, particularly in the context of avoiding storage in government databases, is especially valuable in addressing privacy concerns. Opposition to national identity cards and the like is often fueled by objections to providing government authorities with access to citizen biometric data; these objections may be largely obviated by storing such data on optical cards that remain under the control of the individuals whose information is stored.

Other types of information are not subject to the same types of privacy objections, and it may often be useful to store such information in a centralized database that is accessible to each of the TPUs 204. For instance, if the optical cards are used as identification to receive certain government benefits, a centralized database might record those benefits and the amounts that each individual is entitled to. This is more convenient than storing the information on the card because the amounts may change over time in response to cost-of-living or other adjustments made in the underlying programs. This may also be true of the specific access information in the example described above since a secure facility may reasonably wish to maintain its own records of who has been granted access. The system shown in FIG. 2B illustrates a system in which the TPUs are additionally connected with an electronic network 212 that has access to databases or other data-storage sources 216. The network may comprise the Internet or other wide-area network, a local-area network, a telephone network, and the like.

A perspective illustration of a TPU 204 in one embodiment is provided with FIG. 3. The device includes a housing 304 within which electronic components adapted to read data from and write data to optical cards is provided, some further description of which is provided below. Additional details regarding components of a TPU are provided in copending, commonly assigned U.S. patent application Ser. No. 09/454,717, entitled “OPTICAL CARD BASED SYSTEM FOR INDIVIDUALIZED TRACKING AND RECORD KEEPING,” filed Dec. 6, 1999 by Jack Harper, the entire disclosure of which is incorporated herein by reference for all purposes. The TPU may include a card slot 316 adapted to accept an optical card so that data may be read from or written to the optical card, a display screen 308 for displaying data about the optical card or transaction being executed, and a printer 312 for generating hard-copy.

Embodiments of the invention allow operation of the optical-card system, including the network of TPUs 204 and the optical cards themselves to be handled in a cryptographically secure manner. Specifically, embodiments of the invention are designed in one embodiment to conform to standards for security levels 1, 2, and 3 as set forth in Federal Information Processing Standards Publication No. 140-1, entitled “SECURITY REQUIREMENTS FOR CRYPTOGRAPHIC MODULES” (“FIPS 140-1”), the entire disclosure of which is incorporated herein by reference for all purposes. Briefly, FIPS 140-1 sets forth standards for increasing levels of cryptographic security for the design and implementation of cryptographic modules. The standards cover such areas as basic design and documentation, module interfaces, authorized roles and services, physical security, software security, operating system security, key management, cryptographic algorithms, electromagnetic interference and compatibility, self-testing, and resistance to reverse-engineering and hacking. Security level 1 specifies basic security requirements for a cryptographic module. Security level 2 provides an additional physical-security requirement to level 1 in the form of tamper-evident coatings or seals and/or pick-resistant locks. Security level 3 enhances the physical security by requiring that the module be held in a strong enclosure and configured for zeroization of critical security parameters upon a breach. Other embodiments are designed to conform to standards for security levels set forth in Federal Information Processing Standards Publication No. 140-2 (“FIPS 140-2”).

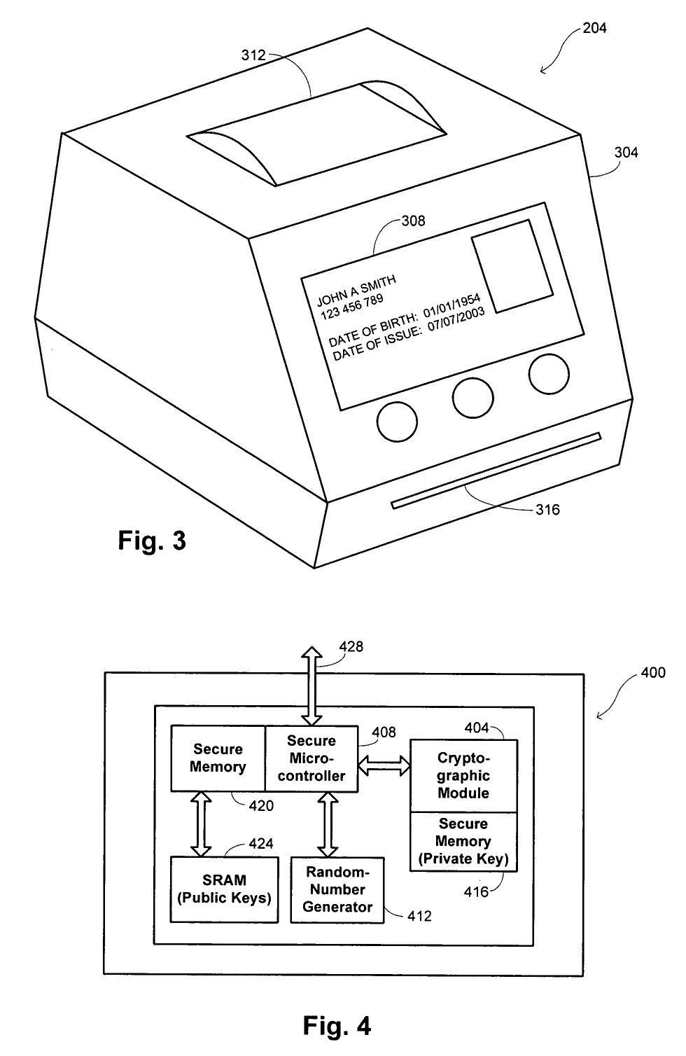

FIG. 4 provides a schematic overview of a cryptographic-key management device 400 that may be comprised by each of the TPUs 204 in the network and which is configured as described below to meet security level 1, 2, and/or 3 as set forth in FIPS 140-11, and/or security levels as set forth in FIPS 140-2. In one embodiment, the cryptographic-key management device 400 is configured for removable engagement within a TPU 204, such as by using a PC/104 form factor for plug-and-play engagement. The cryptographic-key management device 400 acts as a secure repository for cryptographic keys and may in some embodiments also be used for generation and encryption/decryption of keys and key pairs. In an embodiment where the encryption technique uses both a private key and a public key, these keys may be stored in secure memories 416 and 424. Reference to the public and private keys is intended in the context of well known key pairs and does not require that the public key actually be made publicly available; indeed, in many embodiments, both the public and private keys are maintained securely with the cryptographic-key management device 400. Also, as will be evident from the discussion of cryptographic protocols below, the use of a public/private key pair in certain embodiments decreases the amount of plaintext encrypted with any one key. In alternative embodiments, a symmetric-key encryption scheme may be used.

The private key is maintained in secure memory 416 that is comprised by a secure cryptographic module 404, one example of which is the DS1955B cryptographic iButton® available commercially from Dallas Semiconductor Corporation. The cryptographic module 404 is provided in communication with a secure microcontroller, such as the DS5240 Secure Microcontroller chip, also available commercially from Dallas Semiconductor Corporation. The secure microcontroller 408 includes secure memory 420 and controls the operation of other components of the cryptographic-key management device 400, including a random-number generator 412 that may be used in managing cryptographic keys. The public keys for all of the other cryptographic-key management devices 400 in the TPU network are stored in memory 424, which may comprise static random access memory (“SRAM”) or other types of memory, and are securely protected by the microcontroller 408. Bus 428 allows communications to be made between the cryptographic-key management device 400 and other components of the TPU 204 through the microcontroller 408.

The combination of the secure microcontroller 408 and the cryptographic module 404 enable networks having thousands of TPUs and millions of optical cards to operate in a cryptographically secure manner. For example, the DS1955B iButton® and DS5240 are specifically designed to provide an on-chip self-contained cryptographic boundary that is tamper reactive and able to store and manage secret keys securely within the hardware. Other modules and chips having similar capacities are commercially available, as known to those of skill in the art, or may be specially constructed. One feature that may be included in such modules and chips includes fast and substantially complete zeroization of security parameters upon breach. One target of an attack on an embedded cryptographic system is frequently physical memory since a simple logic analyzer can easily monitor and decode all data moving on address and data buses. Some embedded systems and smart cards attempt to achieve at least some security by using microcontrollers that have internal floating-gate memory, such as EPROM or FLASH. Erasure of floating-gate memory cells requires considerable time for both EPROM and FLASH memory. Moreover, floating-gate technologies are intrinsically nonvolatile and maintain the cell contents when power is removed; the decay time is typically on the order of hundreds of years, giving attackers time to breach physical chip defenses to access protected information. In contrast, the use of rapid zeroization of keys protected by the cryptographic module 404 and/or the secure microcontroller 408 provides much greater security.

The same zeroization used by the protective on-chip systems may also be initiated by the cryptographic module 404 and/or secure microcontroller 408 when certain off-chip tamper-detection systems are activated. For example, the devices may include an additional metal layer die top coating designed to prevent microprobe attacks on the chip itself even when the chip is not powered. The layer comprises an interweave of power and ground that are connected to logic protecting the keys so that any attempt to remove the layer results in zeroization. The tamper response, when activated, thus rapidly erases internal encryption keys, interrupt vector tables, and data that may be stored in memory. The secure microcontroller 408 may also comprise an on-chip hardware encryption/decryption engine that operates at substantially the same rate as the machine instruction scheme. For example, the encryption/decryption engine could comprise a triple-DES engine. This engine is used to perform a cryptographic operation on each program fetch, so that data such as encryption keys and controlling software are never seen outside the processor as plaintext.

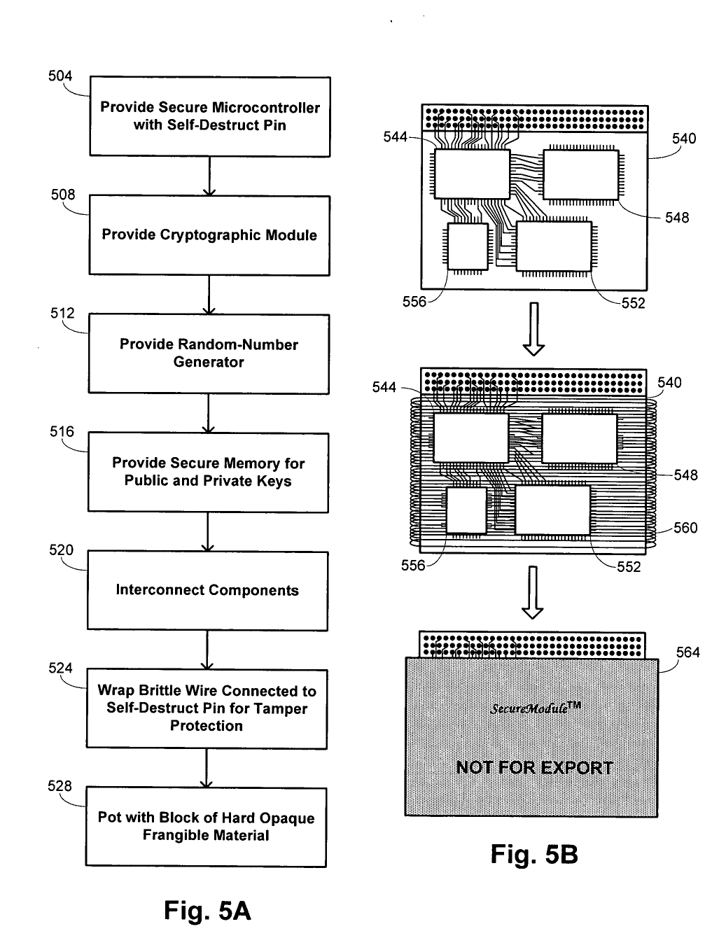

In addition, in some embodiments, the microcontroller 408 may comprise one or more self-destruct pins that cause rapid, substantially complete zeroization of protected memory when their lines are disturbed, even when the unit is not powered. For example, one such pin may be connected to external off-chip tamper sensors configured inside the TPU housing 304. The operation of another such pin may be used to provide enhanced protection in combination with encapsulating the cryptographic-key management device 400 as illustrated in FIGS. 5A and 5B. FIG. 5A is a flow diagram illustrating a method for fabricating a cryptographic-key management device in accordance with an embodiment of the invention, and FIG. 5B schematically shows stages of the device during that fabrication method.

The specific sequence shown in FIG. 5A is not intended to be exclusive; in other embodiments, some of the acts may be omitted, some additional acts may be performed, and/or the recited order of acts may be changed without exceeding the intended scope of the invention. The various modules of the cryptographic-key management device are provided on a surface 540, including the microcontroller 544 having a self-destruct pin at block 504. At block 508, the cryptographic module 548 is provided on the surface 540. At block 512 a random-number generator 552 is provided on the surface 540. At block 516, secure memory is provided for public and private cryptographic keys. In some embodiments, this memory may be comprised by the microcontroller 544 and/or cryptographic module 548; in other embodiments, the memory may be appropriate for storage of a symmetric key if such an encryption technique is used. In the illustrated embodiment, memory 556 is provided for storage of the public keys while memory to store the private key is comprised by the cryptographic module 540. At block 520, the components on the surface 540 are interconnected as appropriate for implementing the encryption protocol to produce the structure shown schematically in the top panel of FIG. 5B.

At block 524, brittle wire is connected to the microcontroller self-destruct pin. The inventor has found that #40 fine nichrome wire has suitable characteristics, although other types of wire may be used in alternative embodiments. The brittle wire may be wrapped about the surface 540 as shown in the central panel of FIG. 5B. In some instances, such wrapping may have multiple layers, such as two, three, four, or more layers, increasing the difficulty of reaching active components of the cryptographic-key management device without encountering the wire. Damage to the wire, such as would result from attempted tampering with the cryptographic-key management device would produce a disturbance that activates the self-destruct pin to zeroize the protected memory. The surface 540 may then be potted with a block of hard opaque frangible material 564 at block 528 to produce the structure shown in the lower panel of FIG. 5B; trademark or other information may be printed on the material 564 as shown. Suitable substances for material 564 include mixtures of epoxy substances with ground silica, alumina, of a filled encapsulate. Such materials make it extremely difficult to machine or laser ablate the surrounding block without triggering the automatic zeroization mechanisms that obliterate the secret keys.

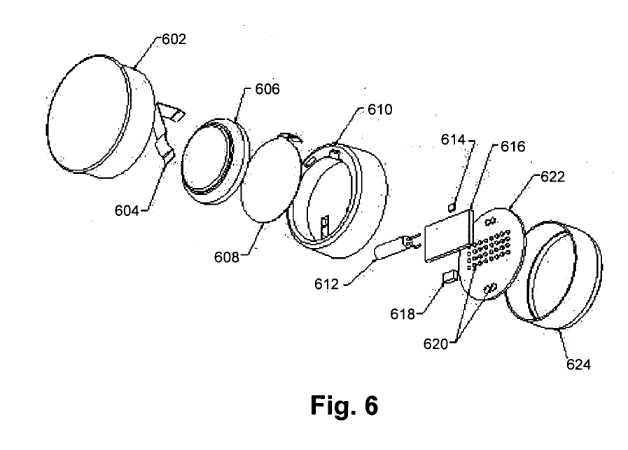

An exemplary structure of the cryptographic module is shown in FIG. 6, which is adapted from a figure provided in the technical document “DS 1955B Java™-powered Cryptographic iButton®: FIPS 140-1 NonProprietary Cryptographic Module Security Policy,” produced by Dallas Semiconductor Corporation and published by the Computer Security Resource Center of the National Institute of Standards and Technology at http://csrc.nist.gov/cryptval/140-1/140sp/140sp111.pdf. This document is incorporated herein by reference in its entirety for all purposes. FIG. 6 provides an exploded view of the DS1955 iButton®, which may be used as the cryptographic-module in an embodiment. The module holds a DS83C960 cryptographic chip 616 within a protective stainless-steel can 602 having lid 624. This external structure does not include any holes or vents that could permit probing. The chip 616 is protected by a barricade 622, which is bonded with metallurgical bonds 620, and by an electrostatic discharge suppressor 614. A quartz timing crystal 612 provides a true time clock for the chip 616 and an energy reservoir 618 provides a parasitic capacitance power for the chip 616. Backup power is provided by a lithium cell 606, which is supported by grommet 610 and kept in electrical contact with the chip through microswitches 604 and 608. The switch contacts are monitored constantly so that any separation of the chip 616 from the lithium cell 606 switches the device to on-chip capacitor power to perform substantially complete zeroization as its last powered action. The device may also include temperature monitors so that deviation from standard operational temperatures of about −20° C. to 70° C. cause zeroization.

There are a variety of different structures that may be used for the random-number generator 412. This includes software-based generators that supply an initial seed as a starting value to an algorithm to generate a sequence of pseudorandom numbers that meet certain distribution and repetition constraints. For security applications, one weakness with such algorithmic generators is that the algorithm may be subject to reverse engineering so that, coupled with a deduction of the initial seed or any subsequent seedlet, it

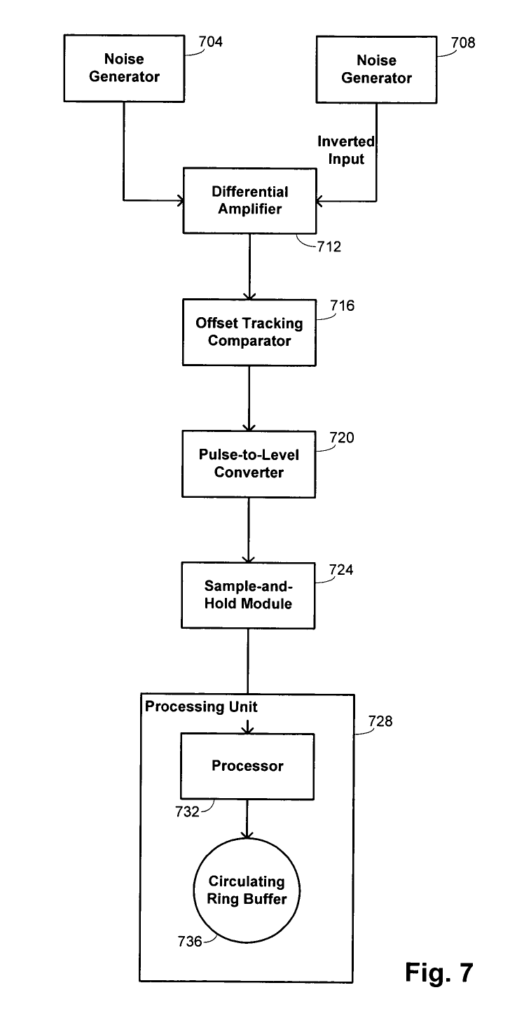

may allow the sequence to be predicted. Much greater security may be achieved with a hardware-based random-number generator, one example of which is illustrated schematically in FIG. 7 for an embodiment of the invention.

This structure produces random numbers by generating random electronic noise by known quantum processes, and then amplifying and sampling that noise. In the illustrated embodiment, two separate noise generators 704 and 708 are provided. Each of the noise generators 704 and 708 may comprise a plurality of transistors. A first of the transistors has its base-emitter junction reverse-biased into a breakdown region that generates quantum random current shot noise. As is known to those of skill in the art, shot noise is caused by random fluctuations in the motion of charge carriers in a conductor; quantum shot noise reflects variations in current that arise from quantum effects of the discreteness of electrical charge. The shot noise is fed into another of the transistors, which is configured as a normal common emitter configuration to act as a current-to-voltage converter. Negative feedback may be employed to provide stabilization of a dc bias point and to minimize the effect of transistor-component variations. The noise voltage may also be fed back to the reverse-biased transistor to limit noise-generation pulse width.

The two random shot-noise generators feed the resulting pulses into a differential amplifier 712. For example, the amplifier 712 may have a first input that receives the signal incoming from noise generator 704 and a second input that inverts the signal incoming from noise generator 708. This property acts to subtract the signals from the two generators 704 and 708 so that any signal components that are common to both, such as ambient electrical noise, are canceled out to eliminate external periodic interference that may be introduced to the circuit by such sources as a power supply, a ground bounce from associated digital circuitry, electromagnetic interference, and the like. In some embodiments, a second operational amplifier may be used as a ground generator to supply a virtual ground to the differential amplifier to improve operation.

The conditioned random response is then fed into an analog comparator 716, which may have its trigger reference derived by scaling and integrating its input signal to make an offset tracking comparator to quantize the analog noise. The offset is desirable so that the noise pulse rate is limited and the noise entropy is enhanced. The narrow quantized noise may then be converted to a digital signal by converter 720. For example, in one embodiment the conversion may be performed by clocking a JK flip flop with the quantized noise. The random bit stream may then be sampled and synchronized for processing by a processing unit 728 by a sample-and-hold module 724, which in one embodiment also comprises a JK flip flop. In embodiments where the random-number generator is comprised by the cryptographic-key management device 400, the processing unit may correspond to the secure microcontroller 408. Residual bias may be removed by a processor 732 comprised by the processing unit 728 programmed to apply an algorithm such as the classic von Neumann method, with the stream of random bits being injected into a circulating ring buffer 736 also comprised by the processing unit.

The random-number generator described above has been tested empirically for 10⁹ bits over the course of 10³ independent trials to verify that the output is as random as the underlying quantum physics on which the device relies. These tests were performed using the NIST 800-22 RNG test suite described in NIST Special Publication 800-22 entitled “A STATISTICAL TEST SUITE FOR RANDOM AND PSEUDORANDOM NUMBER GENERATORS FOR CRYPTOGRAPHIC APPLICATIONS,” by Andrew Rukhin et al. (“Rukhin”), which is available at http://csrc.nist.gov/publications/nistpubs/800-22/sp-800-22-051501.pdf and which is incorporated herein by reference in its entirety for all purposes. The results of these tests are summarized in Table I.

TABLE I
Results of Random-Number-Generator Tests

| | | Pass:Fail | Uniformity | |
|---|---|---|---|---|
| Test | Description | Proportion | Value P₀ | Result |
| 1 | Monobit Frequency | 985:15 | 0.655854 | Pass |
| | | (0.985) | | |
| 2 | Block Frequency | 986:14 | 0.755819 | Pass |
| | | (0.986) | | |
| 3 | Runs | 985:15 | 0.140453 | Pass |
| | | (0.985) | | |
| 4 | Longest Run | 987:13 | 0.063615 | Pass |
| | | (0.987) | | |
| 5 | Binary Matrix Rank | 993:7 | 0.796268 | Pass |
| | | (0.993) | | |
| 6 | Fourier Transform | 997:3 | 0.008446 | Pass |
| | | (0.997) | | |
| 7 | Nonperiodic Template | 146488:1512 | 0.041723 | Pass |
| | | (0.990) | | |
| 8 | Overlapping Template | 991:9 | 0.091487 | Pass |
| | | (0.991) | | |
| 9 | Universal Statistic | 987:13 | 0.723804 | Pass |
| | | (0.987) | | |
| 10 | Compression | 983:17 | 0.029996 | Pass |
| | | (0.983) | | |
| 11 | Linear Complexity | 981:19 | 0.649612 | Pass |
| | | (0.981) | | |
| 12 | Serial | 1968:32 | 0.326749 | Pass |
| | | (0.984) | | |
| 13 | Approximate Entropy | 985:15 | 0.165340 | Pass |
| | | (0.985) | | |
| 14 | Cumulative Sums | 1969:31 | 0.985564 | Pass |
| | | (0.985) | | |
| 15 | Random Excursions 1 | 4877:51 | 0.489224 | Pass |
| | | (0.990) | | |
| 16 | Random Excursions 2 | 11022:66 | 0.04849 | Pass |
| | | (0.994) | | |

The test number in the table corresponds to a subsection of Rukhin that describes the test in detail, i.e. Test X is described in subsection 2.X of Rukhin; the test description in the table is a brief label that corresponds to test identifications provided in Rukhin. In connection with Rukhin, it is noted that the block size M for test 2 is 20,000; the template length m for tests 7 and 8 is 10; the block size L for test 9 is 12 and the initialization steps Q for test 9 is 40,960; the block size M for test 11 is 1,000; and the block size m for tests 12 and 13 is 2.

Rukhin recommends two approaches for interpreting results of the tests. First, the proportion of successes versus failures for each test should be considered; this is summarized for each test in the third column of Table I. For any nonzero statistical significance level α, a certain proportion of successes and failures are expected. Too few successes indicates that the data exhibit patterns that may be identified by an attacker; similarly, too few failures provides weaknesses since an attacker who knows that a certain bit stream will never fail certain tests has increased chances of determining its output. To decide whether the results lie within an acceptable range, a confidence interval was defined in terms of a true standard deviation for a sample size m=1000 and a significance level α=0.01:

$$\pm 3 \sqrt{\frac{α ( 1 - α )}{m}} = \pm 0.009439 .$$

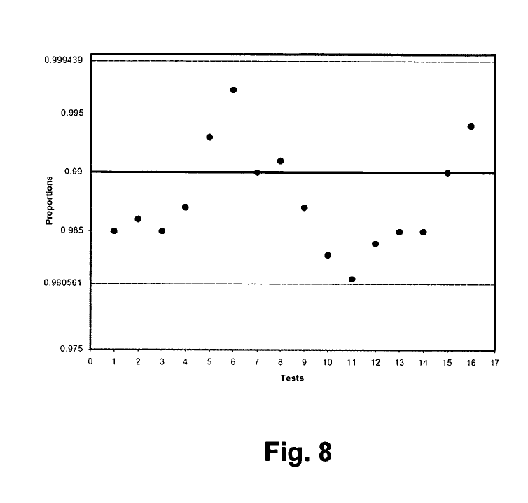

The pass:fail proportion results for the tests of Table I are plotted in FIG. 8, with the bounds of the confidence interval shown in dotted lines. As evident, all of the test results fall within the confidence interval, indicating that this interpretation of the results is consistent with having a reliable random-number generator.

Second, the distribution of results should be examined for conformity with some expectation of uniformity; this is summarized with the uniformity value P₀ in the fourth column of Table I. This uniformity value is derived from multiple P values, each of which is an output for each test and corresponds to the probability that a perfect random-number generator would produce data less random than the data tested. The overall P₀ value was calculated by binning the P values into ten equal intervals between 0 and 1, and using the upper incomplete gamma function,

$${P}_{0} = Γ ( \frac{9}{2} , \frac{{χ}^{2}}{2} ) , \\ where$$

$${χ}^{2} = {\sum }_{i = 1}^{10} \frac{{( {F}_{i} - s / 10 )}^{2}}{s / 10} ,$$

and Fᵢ is the number of P values in interval I and s is the total number of P values. A result of P₀ greater than 0.0001 is considered to identify a substantially uniformly distributed sequence. As is evident from Table I, all of the values of P₀ lie above this threshold, again indicating that this interpretation of the results is consistent with a reliable random-number generator.

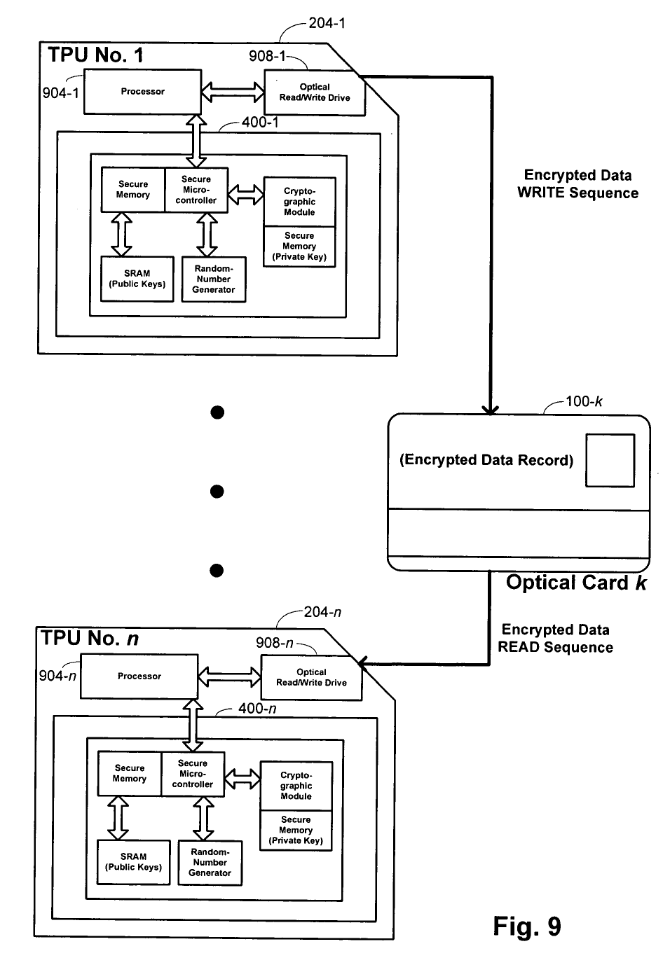

The manner in which the network of TPUs 204 and optical cards 100 may be used in reading and writing encrypted data is illustrated schematically in FIG. 9. In this illustration, each of the TPUs 204 is shown including an optical read/write drive 908 and a processor 904 in addition to the cryptographic-key management device 400. The processor is in communication with both the cryptographic-key management device 400 and optical read/write drive 908 to coordinate operation of them within the TPU. The processor 904 may also coordinate operation of additional components such as a touch screen, control buttons, interfaces to external or integral biometric devices, interfaces to external communication links, and the like, some of which are shown in the physical embodiment depicted in FIG. 3. The read/write optical drive 908 has the capability to read data from optical cards in accordance with instructions from the processor 904 and to write data to optical cards. A variety of models of such optical read/write devices will be known to those of skill in the art, including, for example, various models available from Drexler Technology Corporation of Mountain View, Calif.

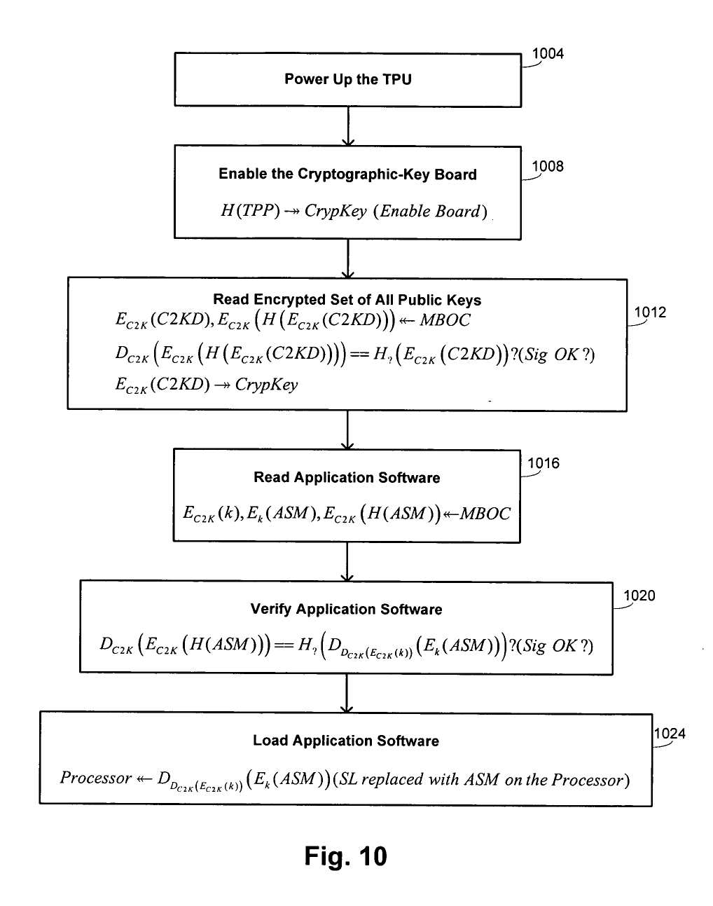

As indicated in FIG. 9, one of the TPUs 204 may be used to write encrypted data onto an optical card 100 and the data may subsequently be read from the optical card 100 by another TPU 204. FIGS. 10-12 provide flow diagrams that illustrate a secure cryptographic protocol used in some embodiments to perform such read and write operations securely.

The ability to perform read and/or write operations begins by booting a TPU so that it is in a ready state to encrypt or decrypt data according to the cryptographic protocol as necessary. The flow diagram of FIG. 10 illustrates such a boot operation, which begins at block 1004 by powering the TPU. Such powering activates a secure loader, which may be stored in FLASH memory in the TPU, to receive, in one embodiment, a text pass phrase (“TPP”) from a human operator. The TPP is specific to the cryptographic-key management device comprised by that TPU. The TTP is one-way hashed to yield a multibit string, which, when confirmed, will enable further operations of the cryptographic-key management device. In one embodiment, the multibit string is approximately 160 bits. To yield a multibit string of this length, the TPP may be about twenty typical English words (e.g., “The time has come, the walrus said . . . ”), preferably not a literary phrase that would be susceptible to a dictionary attack, but still a phrase easily remembered by the TPP owner. The TPP may be hashed with a one-way cryptographically secure hash function, such as the NIST 160-bit secure hash algorithm (“SHA”). The result is written to the cryptographic-key management device (“CrypKey”) as indicated in the following formalism:
H(TPP) [symbol] CrypKey (Enable Board).
In this formalism, the notation A [symbol] B is used to denote that A is written to B, and H identifies the hashing operation.

At block 1012, the encrypted set of all public keys is read. This may be done initially by having the secure loader read a master boot optical card (“MBOC”), which has data for initializing the cryptographic-key management device:
E_{C}_{C2K}(C2KD),E_{C2K} (H(E_{C2K}(C2KD))) [symbol] MBOC.
The notation A [symbol] B is used to denote that B is written to A. The master boot optical card provides a file of decrypting public keys C2KD for each cryptographic-key management device in the network. This file is always encrypted with the private key C2K of the specific cryptographic-key management device where it is maintained, as indicated by the expression E_{C2K} (C2KD). The file will usually also have been previously signed by the specific cryptographic-key management device as E_{C2K} (H(E_{C2K}(C2KD))). This expression is decrypted with the private key so that the signature may be verified by performing a comparison of how the public keys have been hashed:
D_{C2K}(E_{C2K}(H(E_{C2K}(C2KD))))==H_{?}(E_{C2K}(C2KD))?(Sig OK?).
In this expression, decryption with the private key is denoted with the operator D_{C2K} and H_{?} is used to denote the verification operation, i.e. the question “Does the calculated one-way hash value equal the hash value that was stored and then read?” is denoted H_{?}(m)==H(m)? If the signature is verified in this way, the encrypted public keys are written to the cryptographic-key management device:
E_{C2K}(C2 KD) [symbol] CrypKey.
Having been supplied with the public keys, the cryptographic-key management device of the TPU is ready to decrypt secure traffic received from optical cards that was securely written by any other TPU in the network.

An application software module (“ASM”) may similarly be provided to the processor to replace the secure loader. The ASM is read from the master boot optical card at block 1016:
E_{C2K}(k), Eₖ(ASM), E_{C2K}(H(ASM)) [symbol] MBOC.
As indicated, the ASM on the master boot optical card is encrypted with a random session key k, Eₖ(ASM), which is itself encrypted by the private key C2K, E_{C2K}(k). The random key k may be, for instance, an encryption key used with a symmetric encryption algorithm, and may be generated by the random-number generator comprised by the cryptographic-key management device. The master boot optical card also includes an encrypted version of the one-way hashed ASM, E_{C2K}(H(ASM)), so that the signature may be verified at block 1020 in the same fashion described above:
D_{C2K}(E_{C2K}(H(ASM)))==H_{?}(D_{D}_{_{C2K}}_{(E}_{_{C2K}}₍ₖ₎₎(Eₖ(ASM)))?(Sig OK?).
If the signature is verified, the application software is started on the processor 904 to replace the secure loader at block 1024:
Processor [symbol] D_{D}_{_{C2K}}_{(E}_{_{C2K}}₍ₖ₎₎(Eₖ(ASM))(SL replaced with ASM on the Processor).
Accordingly, after the boot process illustrated in FIG. 10, data from a master boot optical card has been used securely to supply the processor 904 with application software and to supply the cryptographic-key management device with a record of the public keys for all cryptographic-key management devices in the network.

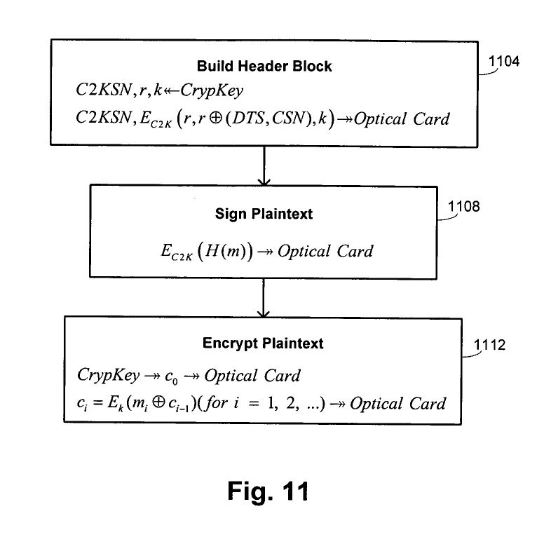

To write a secure record to an optical card, the protocol illustrated with the flow diagram of FIG. 11 may be used. At block 1104, a header block is built. A current date/time stamp DTS and a serial number for the target optical card CSN are packaged into a data record of n bits. The combination of information is thus information uniquely associated with encryption of the record. The use of a date/time stamp in this information prevents fraudulent duplication of cloned records, and the use of the optical-card serial number prevents block-relay types of attacks. In applications where block-relay attacks are of less concern, the package may omit the optical-card serial number, and some alternative embodiments may use a substitute for the date/time stamp to provide a different form for the unique information. The cryptographic-key management device is asked by the processor 904 to generate two random numbers r and k using the random-number generator and to supply a serial number C2KSN that unique identifies the cryptographic-key management device:
C2KSN, r, k [symbol] CrypKey.
Random number r may have a length of n bits, i.e. equal in length to the package of DTS and CSN, and random number k may be used as a session key, having a length of 128 bits in one embodiment. The cryptographic-key management device then encrypts, with its private key C2K, a data record that includes r, r ⊕(DTS, CSN), and k, where the symbol ⊕ is used to denote an exclusive-OR (XOR) operation. The result is combined with serial number C2KSN and written to the optical card as the header:
C2KSN, E_{C2K}(r,r⊕(DTS,CSN),k) [symbol] Optical Card.
This technique may be expressed more generally as encrypting plaintext M with key X by using a random number R to blur the plaintext and make its unauthorized recovery much more difficult: E_{X}(R, R⊕M). In the specific application at hand, the plaintext is M=(DTS, CSN) and the key is X=C2K. While authorized recovery of the plaintext may be achieved by performing the operation R⊕D_{X}(E_{X}(R, R⊕M)), the blurring of the plaintext with random number r complicates its unauthorized recovery, enhancing the overall security of the system.

After the header block has been written to the optical card, the actual record may be written in encrypted form. At block 1108, the plaintext m of the record is signed by calculating a one-way hash H of the plaintext and encrypting the result with the private key for writing to the target optical card:
E_{C2K}(H(m)) [symbol] Optical Card.
The record itself may then be encrypted and written to the optical card at block 1112. In one embodiment, a symmetric algorithm is used to encrypt the plaintext m with the randomly generated key k. Security can be further enhanced in other embodiments by using block chaining to reduce the effectiveness of plaintext or block-repeat attacks. For instance, the cryptographic-key management device may be asked to return another random number co from the random-number generator, which may be used as an initialization vector for the block-chaining algorithm and which is recorded on the optical card:
CrypKey [symbol] c₀ [symbol] Optical Card.
Blocks of plaintext m₁, m₂, m₃, . . . are then encrypted successively and written to the optical card by performing the exclusive-or operation with the chain of c values:
cᵢ=Eₖ(mᵢ⊕cᵢ₋₁)(for i=1, 2, . . . ) [symbol] Optical Card.
For example, if the plaintext is encrypted in eight-byte blocks, the c values may comprise 64-bit numbers. This technique significantly increases the security of the record written to the optical card. Including the header information, the complete secure record for writing plaintext m to the optical card is thus:
C2KSN, E_{C2K}(r,r⊕(DTS,CSN),k), E_{C2K}(H(m)), c₀, Eₖ(m₁⊕cᵢ₋₁) (for i=1, 2, . . . ).

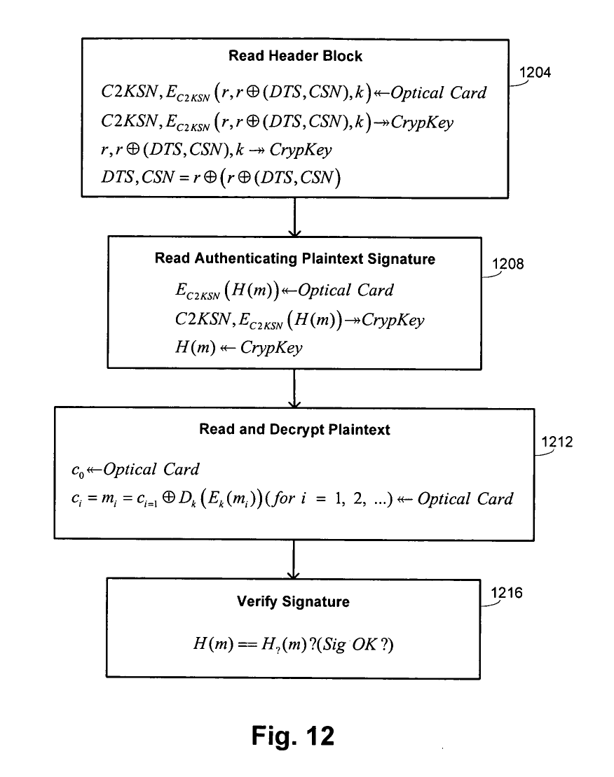

The flow diagram of FIG. 12 illustrates how such a secure record may subsequently be read and decrypted by a different TPU in the network. When an optical card having information written to it is received by a TPU, the information is extracted by initially reading the header block at block 1204. As seen from the complete expression of the securely written record, the first item in the header record is the uniquely identifying serial number C2KSN of the writing cryptographic-key management device, and the second item is the encrypted version of the date/time stamp DTS, the optical-card serial number CSN, and session key k: E_{C2KSN}(r,r⊕(DTS,CSN),k). In this expression, the subscript of the encryption operator E is C2KSN to emphasize that the decryption by the reading TPU may be performed with the public key corresponding to the private key of the writing unit. Accordingly, these header records are read from the optical card and provided to the cryptographic-key management device:
C2KSN,E_{C2KSN}(r,r⊕(DTS,CSN),k) [symbol] Optical Card
C2KSN,E_{C2KSN}(r,r⊕(DTS,CSN),k) [symbol] CrypKey.
The identification of the writing-unit serial number C2KSN is used to look up the securely stored public key of the writing unit from the record of all public keys C2 KD. This public key is used to decrypt the encrypted header information,
r,r⊕(DTS,CSN),k [symbol] CrypKey,
with the date/time stamp DTS and card serial number CSN being recovered from the extracted identification of the n-bit random number r:
DTS,CSN=r⊕(r⊕(DTS,CSN).
The extracted card serial number CSN is verified to ensure that it matches the serial number of the card being read; a failure for these numbers to match is generally indicative of some type of fraud, such as that a block-replay attack is underway or that a record has been cloned from another card and illicitly written to the card being read.

At block 1208, the authenticating plaintext signature is extracted from the next record read from the card after the header, E_{C2KSN}(H(m)), where again the subscript of the encryption operator E has been written as C2KSN to emphasize that the public key for the writing unit may be used to perform the decryption. This record is thus read from the optical card and provided to the cryptographic-key management device with the writing-unit serial number C2KSN so that the authenticating signature H(m) may be extracted:
E_{C2KSN}(H(m)) [symbol] Optical Card
C2KSN, E_{C2KSN}(H(m)) [symbol] CrypKey
H(m) [symbol] CrypKey.
As before, the decryption performed by the cryptographic-key management device proceeds by looking up the public key corresponding to the writing unit in the public-key repository C2 KD and applying it.

The plaintext is read and decrypted at block 1212. The next record on the optical card is the block-chain initialization vector c₀:
c₀ [symbol] Optical Card.
Each of the other encrypted blocks Eₖ(cᵢ) may be read and decrypted with the symmetric algorithm and symmetric session key k:
cᵢ=mᵢ=cᵢ₌₁⊕Dₖ(Eₖ(mᵢ)) (for i=1, 2, . . . ) [symbol] Optical Card.
The decrypted plaintext m may then be used to verify the signature by calculating the one-way hash of the decrypted plaintext m and verifying that it equals the previously decrypted signature H(m):
H(m)==H_{?}(m)?(Sig OK?).
If so, the plaintext may be provided to the processor 904 of the reading TPU so that a transaction may be executed with it.

This cryptographic protocol, particularly when combined with the physical security features of the cryptographic-key management device described above, provides very high security of the information on optical cards. The fast and complete zeroization of keys and other items, combined with the several layers of physical tamper-attack sensing that conform at least to security levels 1, 2, and 3 of the FIPS 140-1 standards, provides security that is in some embodiments greater than that provided by high-level smart-card systems. The one-way hash that implements a digital signature enables all records to be authenticated, verified for integrity, and nonrepudiable. The effect of known plaintext and dictionary attacks are greatly mitigated by using the technique of blurring certain plaintext with random strings, i.e. by construction of the (r, r⊕m) string. The digital signature authentication also prevents so-called “Man in the Middle” attacks from being effective. Similarly, the possibility of so-called “Trojan Horse” attacks is also prevented because attacking software cannot obtain a copy of the one-way hash of the text pass phrase that is securely stored in the protected memory; a particular cryptographic-key management device will not function at all until it receives the multibit string derived from the text pass phrase. Furthermore, the protocol detects illicitly cloned optical cards because each secure record contains the unique serial number of the original card to which it was written in encrypted form.

Even theft of a TPU containing a cryptographic-key management device would not seriously compromise the security of the system. If a unit is stolen and an attempt made to reverse engineer the system, the file of all public keys and individual private key remain securely protected by the physical mechanisms described above. For example, to recover the private key for a particular cryptographic-key management device would require the complete destruction of the device in some embodiments. Moreover, a stolen cryptographic-key management device will still fail to respond to meaningful commands until it has been activated with the correct text pass phrase. There can be no realistic chance of a successful attack without theft of the physical TPU with its cryptographic-key management device, theft of the corresponding master boot optical card, and theft of the text pass phrase. It is accordingly preferable in some embodiments to store the master boot optical card separately from the TPU in a secure manner, and also to secure the text pass phrase. To further mitigate the impact in cases where a TPU is stolen, a list of missing or compromised TPUs may occasionally or periodically be circulated. Such a list may conveniently be distributed on optical cards that provide each of the uncompromised TPUs in a network with notification to ignore records identified as originating with potentially compromised units.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A cryptographic-key management device comprising:
a secure cryptographic module comprising a first memory storing a private cryptographic key of a plurality of public/private key pairs, the secure cryptographic module adapted to zeroize the first memory in response to physical disruption of the module;
a secure microcontroller in communication with and adapted to control operation of the secure cryptographic module, the secure microcontroller comprising a second memory storing the public keys of the plurality of public/private key pairs and a self-destruct pin whose activation disables the microcontroller; and
a package encapsulating the secure cryptographic module and the secure microcontroller, the package linked with the self-destruct pin to activate the self-destruct pin in response to a breach of the package.

2. The cryptographic-key management device recited in claim 1 wherein the physical disruption of the module comprises a breach of a container housing the first memory.

3. The cryptographic-key management device recited in claim 1 wherein the physical disruption of the module comprises a deviation in a temperature of the module outside of a predefined range.

4. The cryptographic-key management device recited in claim 1 wherein the physical disruption of the module comprises a deviation in strength of an electromagnetic field near the module outside of a predefined range.

5. The cryptographic-key management device recited in claim 1 wherein the package comprises a brittle wire connected with the self-destruct pin.

6. The cryptographic-key management device recited in claim 5 wherein the brittle wire is wrapped about the secure cryptographic module and secure microcontroller.

7. The cryptographic-key management device recited in claim 6 wherein the brittle wire is wrapped in multiple layers about the secure cryptographic module and secure microcontroller.

8. The cryptographic-key management device recited in claim 1 wherein the package comprises an encapsulating material that includes an epoxy substance and at least one of a silica and an alumina.

9. The cryptographic-key management device recited in claim 1 wherein the secure microcontroller comprises a second self-destruct pin whose activation disables the microcontroller, the second self-destruct pin connected with a tamper sensor external to the cryptographic-key management device and internal to a housing surrounding the cryptographic-key management device.

10. The cryptographic-key management device recited in claim 1 further comprising a random-number generator in communication with the secure microcontroller.

11. The cryptographic-key management device recited in claim 10 wherein the random-number generator is a hardware random-number generator.

12. A method for fabricating a cryptographic-key management device, the method comprising:
providing a secure cryptographic module comprising a first memory and adapted to zeroize the first memory in response to physical disruption of the module;
providing a secure microcontroller in communication with the secure cryptographic module, the secure microcontroller comprising a second memory and a self-destruct pin whose activation disables the microcontroller;
storing a private cryptographic key of a plurality of public/private key pairs in the first memory;
storing the public keys of the plurality of public/private key pains in the second memory; and
encapsulating the secure cryptographic module and the secure microcontroller within a package linked with the self-destruct pin to activate the self-destruct pin in response to a breach of the package.

13. The method recited in claim 12 wherein the physical disruption of the module comprises a breach of a container housing the first memory.

14. The method recited in claim 12 wherein the physical disruption of the module comprises a deviation in a temperature of the module outside of a predefined range.

15. The method recited in claim 12 wherein the physical disruption of the module comprises a deviation in strength of an electromagnetic field near the module outside of a predefined range.

16. The method recited in claim 12 wherein encapsulating the secure cryptographic module and the secure microcontroller within a package comprises connecting a brittle wire with the self-destruct pin.

17. The method recited in claim 16 wherein encapsulating the secure cryptographic module and the secure microcontroller within a package further comprises wrapping the brittle wire about the secure cryptographic module and secure microcontroller.

18. The method recited in claim 17 wherein wrapping the brittle wire about the secure cryptographic module and secure microcontroller comprises wrapping the brittle wire in multiple layers about the secure cryptographic module and secure microcontroller.

19. The method recited in claim 12 wherein the package comprises an encapsulating material than includes an epoxy substance and at least one of a silica and an alumina.

20. The method recited in claim 12 wherein the secure microcontroller comprises a second self-destruct pin whose activation disables the microcontroller, the method further comprising connecting the second self-destruct pin with a tamper sensor.

21. The method recited in claim 12 further comprising providing a random number generator in communication with the secure microcontroller.

22. The method recited in claim 21 wherein the random number generator is a hardware random-number generator.

23. An optical-card network comprising:
a plurality of transaction processing units, each such unit comprising:
a cryptographic-key management device having a securely stored private key for that cryptographic-key management device and securely stored public keys for a plurality of cryptographic-key management devices comprised by the network;
an optical-card read/write drive in communication with the cryptographic-key management device and adapted to exchange data with optical cards; and
a processor in communication with and adapted to control operation of the cryptographic-key management device and the optical-card read/write drive; and
a plurality of optical cards.

24. The optical-card network recited in claim 23 wherein information may be exchanged among the plurality of transaction processing units only with the plurality of optical cards.

25. The optical-card network recited in claim 23 wherein the plurality of transaction processing units are interconnected electronically.

26. The optical-card network recited in claim 23 wherein the cryptographic-key management device comprises:
a secure cryptographic module comprising a first memory storing the private cryptographic key and adapted to zeroize the first memory in response to physical disruption of the module;
a secure microcontroller in communication with and adapted to control operation of the secure cryptographic module, the secure microcontroller comprising a second memory storing the public keys and a self-destruct pin whose activation disables the microcontroller; and
a package encapsulating the secure cryptographic module and the secure microcontroller, the package linked with the self-destruct pin to activate the self-destruct pin in response to a breach of the package.

27. The optical-card network recited in claim 26 wherein the package comprises a brittle wire connected with the self-destruct pin and wrapped about the secure cryptographic module and secure microcontroller.

28. The optical-card network recited in claim 26 wherein the package comprises an epoxy substance and at least one of a silica and an alumina.

29. The optical-card network recited in claim 26 wherein:
the each such unit further comprises a tamper sensor; and
the secure microcontroller comprises a second self-destruct pin whose activation disables the microcontroller, the second self-destruct pin connected with the tamper sensor.
